(19) United States
(12) Patent Application Publication
(10) Pub. No.: US 2003/0191219 A1
(43) Pub. Date: Oct. 9, 2003

(54) Barrier reducing permeation of hydrocarbons

(76) Inventor: Ronald T. Robichaud, Leominster, MA (US)

Correspondence Address: KANE, DALSIMER, SULLIVAN, KURUCZ,, LEVY, EISELE and RICHARD, 711 Third Avenue, New York, NY, 10017-4059, US

(21) Appl. No.: 10/116,001

(22) Filed: Apr. 5, 2002

(51) Int. Cl. C08K 5/04

(52) U.S. Cl. 524/394; 524/502

(57) ABSTRACT

The present invention is directed to a thermoplastic additive containing aluminum stearate and polyvinylidine fluoride which when added to thermoplastics such as polyethylene inhibits and reduces permeation of fluids stored within containers composed of the thermoplastic. The invention has been proven effective in reducing the permeation of hydrocarbon based materials.

### BACKGROUND OF THE INVENTION

Polyethylene is a favored material used in constructing containers. It is cheaply produced as molded or extruded. However, polyethylene has serious drawbacks. When certain fluids such as hydrocarbon based materials are packaged in polyethylene containers, they have a tendency to seep through the container wall. This is due to the permeable nature of polyethylene.

### SUMMARY OF THE INVENTION

It is an object of the invention to provide a thermoplastic additive which when blended with a thermoplastic serves as a barrier to the permeation of fluids, and in particular, hydrocarbon based materials.

It is a further object of the invention to provide a drum, bottle, container or the like capable of resisting permeation of fluids, and particularly, hydrocarbon based materials.

It is a further object of the invention to provide a thermoplastic additive which can be formed into a liner for containers of other materials, such as metal and paper products, which provides resistance to fluid permeation.

The present invention is a thermoplastic additive which is added to thermoplastics, particularly, polyethylene. The additive is comprised of a carrier thermoplastic, polyvinylidine fluoride, and aluminum stearate as a tie agent, binding the polyvinylidine fluoride and the carrier thermoplastic.

It is also possible to form the blend into a liner suitable for lining metal drums and containers of other materials, thereby serving as extra measure of protection against permeation.

Aluminum stearate is used as an agent capable of gelling or thickening aliphatic and aromatic hydrocarbons. In the present invention, its presence as an additive to thermoplastics or to thermoplastic liners reduces permeation through the container walls. If aliphatic or aromatic hydrocarbons penetrate the interior container wall or interior liner, the presence of aluminum stearate would cause a localized thickening, thereby preventing permeation.

### EXAMPLE

The additive is prepared by mixing polyvinylidine fluoride (PVDF) and aluminum stearate with the carrier thermoplastic. The PVDF can be in either powderized or pelletized form. In this example, the thermoplastic is high molecular weight high density polyethylene (HMW-HDPE). The components of the blend were mixed in the following ratio:

| | |
|---|---|
| HNW-HDPE | 52 lbs. |
| PVDF | 48 lbs. |
| Aluminum stearate | 56 grms/cwt. |

Prior to mixing, the blend is covered. After mixing of the additive, it is suitable for a subsequent blending with a resin of the carrier. The subsequent blending creates a thermoplastic composite that resists and reduces permeation through its walls. It is preferred that after the subsequent mixing with the carrier thermoplastic, the additive comprise 3 to 6% of the total composition of the subsequent composite.

The blend may also be used as a thermoplastic liner for containers of other materials. The liner is applied to the containers by means known by those skilled in the art.

### TEST DATA

Three drums were tested to determine the amount of permeation through the drum walls.

The drums were filled with xylene and then stored for a period of a year. Data reflecting the percentage of fluid permeating through the drum was compiled on a intermittent basis.

Drum #1 was a control drum possessing no permeation resistant additives. Drum #2 possessed a 3% permeation resistant additive as disclosed in the invention. Drum #3 possessed a 6% permeation resistant additive as disclosed in the invention.

| | | | | 1 year |
|---|---|---|---|---|
| | | 30 day/50° C. | 12 weeks/50° C. | at ambient |
| | Drum #1 | 0.7% loss | 2.08% loss | 6.0% loss |
| 3% | Drum #2 | 0.4% loss | 1.1% loss | 4.7% loss |
| 6% | Drum #3 | 0.19% loss | 0.58% loss | 4.6% loss |

As can be seen, the drums containing the additive exhibit a resistance to permeation. The additive brings the drums into compliance with Department of Transportation regulations, which set a maximum of 0.5% loss at 50° C. for a thirty day period for hazardous materials, and 2% loss at 50° C. for a thirty day period at for non-hazardous materials.

I claim:

1. A thermoplastic additive for the reduction of permeation of hydrocarbon based materials comprised of polyvinylidine fluoride, a carrier thermoplastic, and aluminum stearate, said additive being blended with the carrier thermoplastic.

2. The thermoplastic additive of claim 1 wherein the carrier thermoplastic is high molecular weight high density polyethylene.

3. The thermoplastic additive of claim 2 wherein the blend components are comprised and proportioned as follows: 52 lbs. high molecular weight high density polyethylene to 48 lbs. of polyvinylidine fluoride and 56 grams of aluminum stearate per 100 lbs./polyethylene.

4. The thermoplastic additive of claim 4 wherein the blend is added to polyethylene and comprised 3% to 6% of the total composition.

5. A drum for the containing and transporting of fluids, the drum being comprised of a carrier thermoplastic and an additive comprised of polyvinylidine fluoride, the carrier thermoplastic, and aluminum stearate.

6. The drum of claim 5 wherein the carrier thermoplastic is high molecular weight high density polyethylene.

7. The drum of claim 6 wherein the additive components are comprised and proportioned as follows: 52 lbs. high molecular weight high density polyethylene to 48 lbs. of polyvinylidine fluoride and 56 grams of aluminum stearate per 100 lbs./polyethylene.

8. The drum of claim 5 wherein the additive comprises 3% to 6% of the composition of the drum.

9. A thermoplastic blend for the reduction of permeation of hydrocarbon based materials which is capable of being formed into a liner which may be applied to containers suitable for holding fluids said blend being comprised of a carrier thermoplastic, aluminum stearate, and polyvinylidine fluoride.

10. The blend as set forth in claim 9 wherein the carrier thermoplastic is high molecular weight high density polyethylene.

11. The blend as set forth in claim 10 wherein the blend components are comprised and proportioned as follows: 52 lbs. high molecular weight high density polyethylene to 48 lbs. of polyvinylidine fluoride and 56 grms. aluminum stearate per 100 lbs./polyethylene.
